(19) United States
(12) Patent Application Publication
(10) Pub. No.: US 2008/0006777 A1
(43) Pub. Date: Jan. 10, 2008

(54) LITHOGRAPHY SYSTEM AND ERROR DETECTION METHOD IN SAME

(75) Inventor: Hideo INOUE, Mishima-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: NuFlare Technology, Inc., Numazu-shi (JP)

(21) Appl. No.: 11/762,498

(22) Filed: Jun. 13, 2007

(30) Foreign Application Priority Data
Jul. 5, 2006 (JP) 2006-185731

(51) Int. Cl. G21K 1/08

(52) U.S. Cl. 250/398

(57) ABSTRACT

The lithography system deflects a beam to draw a desired pattern on a sample. The lithography system includes a beam optical system that includes a deflector deflecting a beam, and a driving unit that drives the deflector. The data generation circuit generates control data to control the driving unit according to the patterning data representing the pattern to be drawn. The data output unit processes the control data and outputs it to the driving unit. The data processing circuit comprises a memory that stores the inputted control data, and a control unit specifies a position where a defect of a pattern exists according to defect data as a result of inspection of a defect of a pattern actually drawn on the sample using a defect inspector and selectively stores in the memory the control data that relates to a peripheral area including the position of the defect.

### CROSS REFERENCE TO RELATED APPLICATIONS

This application is based on and claims the benefit of priority from prior Japanese Patent Application No. 2006-185731, filed on Jul. 5, 2006, the entire contents of which are incorporated herein by reference.

### BACKGROUND OF THE INVENTION

1. Field of the Invention

The present invention relates to a lithography system that draws a pattern by deflecting a beam such as an electron beam, and a method of detecting an error in the lithography system.

2. Description of the Related Art

As the semiconductor circuits have become smaller and more highly integrated, a charged particle beam lithography system has increasingly been used. The system draws a pattern on a mask using a charged particle beam such as an electron beam (see, for example, JP H10-284392).

The charged particle beam lithography system draws a pattern on the mask according to design pattern data of the LSI. The design pattern data from a CAD system or the like needs to be converted into patterning data associated with the charged particle beam lithography system. The patterning data is generated per a frame area. The frame area is defined by a beam deflection width of the main deflector of the charged particle beam lithography system. The patterning data is further generated per a sub-field area. Dividing a frame area generates the sub-field area.

In patterning, the patterning data is read per a frame area. The data is then used to generate main deflection data, auxiliary deflection data, and shot data. The main deflection data corresponds to a position of the sub-field area. The auxiliary deflection data corresponds to a position within the sub-field area. The shot data represents a shot figure such as a rectangular, a trapezoid, a triangle, or the like. After patterning, the development process is performed outside the lithography system, thereby completing the mask.

The mask is then subject to a defect inspection by a defect inspection system for checking whether the pattern is correctly drawn according to the design pattern data. The defect inspector is briefly outlined with reference to FIG. 6. The defect inspector 700 includes, for example, a light source 701, lenses 702, 703, and an image sensor 704, which together provide measured data of the pattern drawn on the sample W. The measured data is converted into measured digital data by the A/D converter 705. The design pattern data of the sample W is previously recorded in the hard disk drive 710. A data conversion circuit 711 converts the design pattern data into a format that can be compared with the measured digital data. The comparison circuit 712 compares the measured digital data with the design pattern data to recognize the difference between the two sets of data as a defect, and generates defect data. The defect data thus indicates the presence and position of a defect in the sample W after the sample W is actually patterned using the electron beam lithography system 1.

When the defect inspection system provides the defect data including the defect position or the like, it is important to determine whether the defect is due to an error in the charged particle beam lithography system or an error in the development process or the like outside the charged particle beam lithography system. Whether the defect is due to an error in the charged particle beam lithography system can be determined as follows. That is, the same design pattern data is actually used to generate various data in the charged particle beam lithography system. The various data is stored in a memory of the system to be compared with the defect data.

The defect data and design pattern data have become very large due to the smaller and more highly integrated semiconductor circuits. However, the memory capacity to store various data for the defect data or design pattern data has a limited value of, for example, approximately 256 KB. The capacity is limited because of the specification of the hardware of the charged particle beam lithography system.

It is thus difficult to efficiently process the defect data to detect an error in the lithography system.

### SUMMARY OF THE INVENTION

According to an aspect of the invention, a lithography system is provided that deflects a beam to draw a desired pattern on a sample, the system comprising: a beam optical system that includes a deflector to deflect the beam; a driving unit that drives the deflector; a data generation circuit that generates control data to control the driving unit according to patterning data representing the pattern to be drawn; and a data processing circuit that processes the control data and outputs the processed data to the driving unit, the data processing circuit comprising: a memory that stores the inputted control data; and a control unit that specifies a position where a defect of a pattern exists according to defect data as a result of inspection of a defect of a pattern actually drawn on the sample using a defect inspector and selectively stores in the memory the control data that relates to a peripheral area including the position of the defect.

According to an aspect of the invention, a method of detecting an error in a lithography system is provided, the method comprising: inputting defect data as a result of inspection by a defect inspector inspecting a defect of a sample patterned by the lithography system; specifying a position of the defect from the defect data; generating, in the lithography system, control data to control the lithography system according to patterning data used in patterning the sample; and selectively storing in a memory the generated control data that relates to a peripheral area including the specified defect position.

### BRIEF DESCRIPTION OF THE DRAWINGS

FIG. 1 is a schematic diagram of a configuration of an electron beam lithography system 1 according to an embodiment of the present invention.

FIG. 2 is a schematic diagram illustrating the patterning operation by the deflectors 31 to 34 in FIG. 1.

FIG. 3 is a block diagram of an example configuration of the data processing circuit 45 in FIG. 1.

FIG. 4 is a schematic diagram of the operation of an electron beam lithography system 1 according to an embodiment of the invention.

FIG. 5 is a flowchart of the operation of an electron beam lithography system 1 according to an embodiment of the invention.

FIG. 6 is a schematic diagram of a configuration of a defect inspector.

### DETAILED DESCRIPTION OF THE EMBODIMENTS

With reference to the accompanying drawings, a lithography system according to an embodiment of the present invention will be described in more detail below.

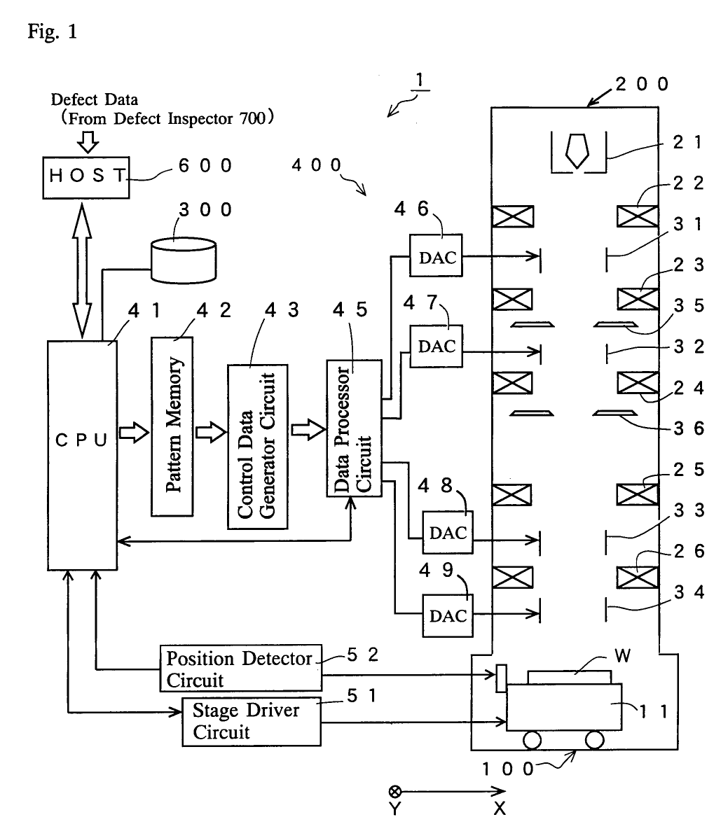

FIG. 1 is a schematic diagram of a configuration of an electron beam lithography system 1 according to an embodiment of the present invention. The electron beam lithography system 1 generally includes a sample chamber 100, an electron beam optical system 200, a hard disk drive 300, and a control unit 400.

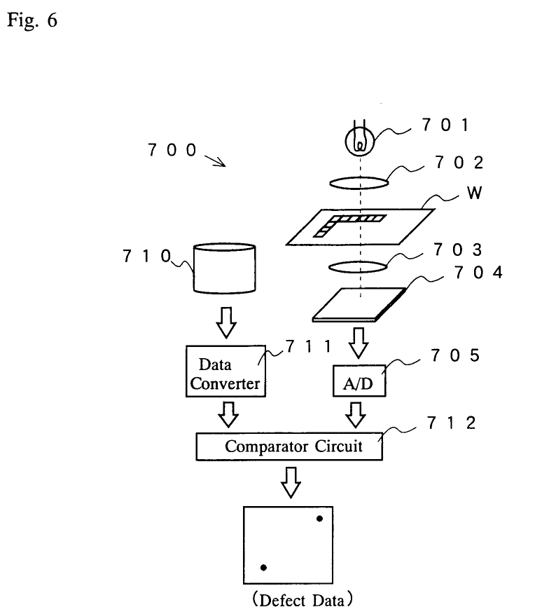

The electron beam lithography system 1 is also adapted to be connectable to an external host computer 600 to allow data to be transferred between them. The host computer 600 receives defect data as input, which is obtained during for example inspection by the defect inspector 700 as illustrated in FIG. 6. The defect data is then input from the host computer 600 to the electron beam lithography system 1.

The sample chamber 100 contains a stage 11 that holds a sample W such as a mask thereon. A stage driver circuit 51 included in the control unit 400 drives the stage 11. The stage 11 is driven in the X direction (the horizontal direction in the plane of FIG. 1) and in the Y direction (the vertical direction in the plane of FIG. 1). A position detector circuit 52 included in the control unit 400 measures the position of the stage after movement.

The electron beam optical system 200 resides in the upper portion of the sample chamber 100. The electron beam optical system 200 includes an electron gun 21, various lens 22, 23, 24, 25, and 26, a blanking deflector 31, a beam size adjusting deflector 32, a main deflector 33, an auxiliary deflector 34, beam shaping apertures 35 and 36, and the like.

The blanking deflector 31 has a function of switching between transmission or shutting off of the electron beam from the electron gun 21. The beam size adjusting deflector 32 has a function of controlling the cross-section of the electron beam using the beam shaping apertures 35 and 36.

The main deflector 33 has a function of positioning the electron beam to a certain sub-field area according to the main deflection data. The auxiliary deflector 34 has a function of positioning where the pattern is drawn in the sub-field area positioned by the main deflector 33 according to the auxiliary deflection data.

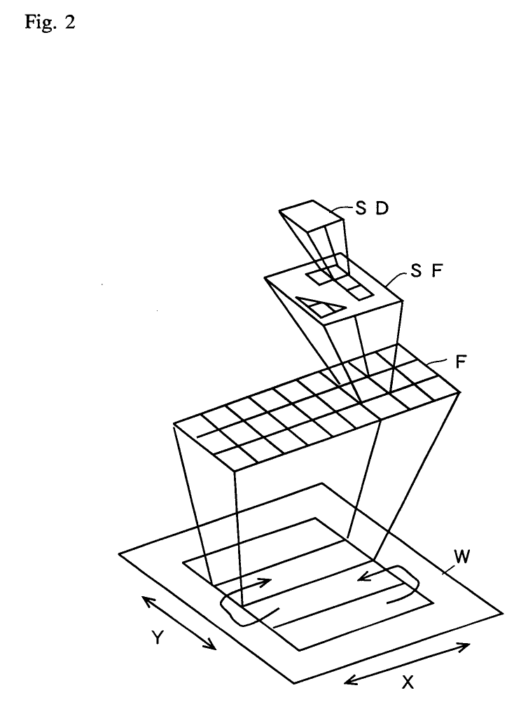

The patterning operations of the deflectors 31 to 34 will be briefly described below with reference to FIG. 2. With the beam shape being controlled by the beam size adjusting deflector 32 and the beam shaping apertures 35 and 36 according to the shot data SD, the stage 11 is continuously moved in the X direction. With the main deflector 33 being controlled to follow the stage motion, the auxiliary deflector 34 is controlled to pattern one sub-field area SF.

Thus, after one sub-field area SF is successfully patterned, the next sub-field area, such as a sub-field SF in the positive Y direction, is then patterned. After the frame area F including a plurality of sub-field areas SF is successfully patterned, the stage 11 is stepwise moved in a direction (Y direction) orthogonal to the continuous motion direction (X direction). Such processes are repeated to sequentially pattern each frame area F. The frame area F is a strip-shaped area to be patterned that depends on the deflection width of the main deflector 33. The sub-field area SF is a unit area to be patterned that depends on the deflection width of the auxiliary deflector 34.

Referring back to FIG. 1, the hard disk drive 300 stores patterning data for use in patterning in the lithography system 1. The patterning data is derived by converting the design pattern data related to the pattern to be drawn.

The control unit 400 includes a CPU 41, a pattern memory 42, a control data generation circuit 43, a data processing circuit 45, DA converters 46 to 49, the stage driver circuit 51 (previously explained), and the position detector circuit 52 (previously explained). The CPU 41 is responsible for the control of the entire control unit 400. The pattern memory 42 temporarily stores, for each frame area F, the patterning data read from the hard disk drive 300 by the instruction from the CPU 41.

The control data generation circuit 43 has a function of generating various control data to control the deflectors 31 to 34 according to the patterning data for each frame area F stored in the pattern memory 42. By way of example, the control data generation circuit 43 generates, as control data, main deflection data to control the main deflector 33, auxiliary deflection data to control the auxiliary deflector 34, shot data for the beam size adjusting deflector 32 to provide the desired beam width, and blanking data to control the blanking operation by the blanking deflector 31. These set of control data are illustrative only and the data type or the like may be changed appropriately according to the configuration of the lithography system. Specifically, any control data may be used that controls the electron beam optical system 200 according to the patterning data representing the pattern to be drawn. The control data may be of any type and any name.

The data processing circuit 45 has a function of outputting the various control data from the control data generation circuit 43 to the D/A converters 46 to 49 at a predetermined timing.

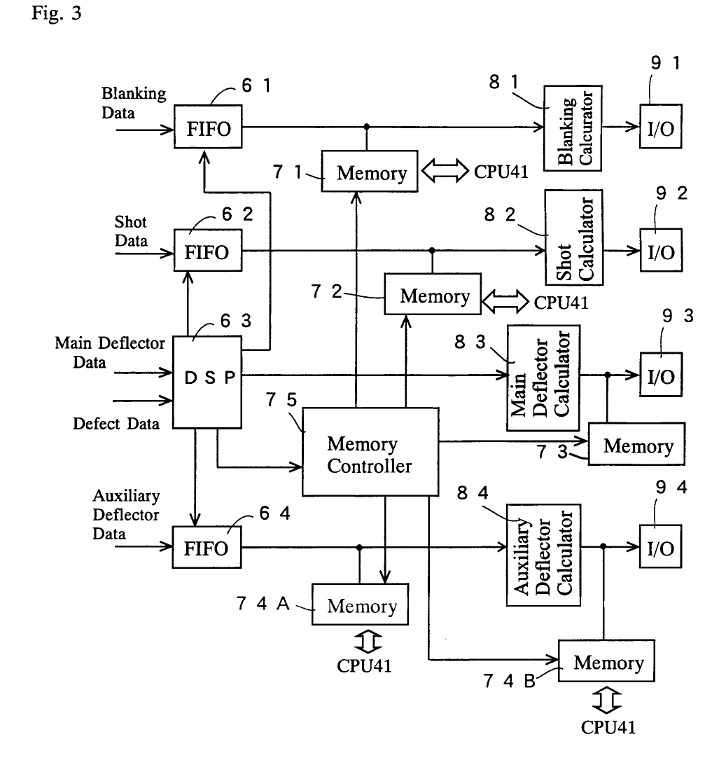

FIG. 3 is a block diagram of an example configuration of the data processing circuit 45. The data processing circuit 45 includes FIFO memories 61, 62, and 64, and a Digital Signal Processor (DSP) 63. The FIFO memories 61, 62, and 64 temporarily store the blanking data, shot data, and auxiliary deflection data, respectively.

The data processing circuit 45 also includes memories 71, 72, 73, 74A, and 74B, as well as a blanking calculation unit 81, a shot calculation unit 82, a main deflector calculation unit 83, and an auxiliary deflector calculation unit 84. The memories 71, 72, 73, 74A, and 74B store various control data for use in maintenance or the like. In this example, the memories 71 to 74B work as follows. The memory 71 stores the output data (blanking data) from the FIFO memory 61. The memory 72 stores the output data (shot data) from the FIFO memory 62. The memory 73 stores the output data from the main deflector calculation unit 83. The memory 74A stores the output data (auxiliary deflection data) from the FIFO memory 64. The memory 74B stores the output data from the auxiliary deflector calculation unit 84.

The data processing circuit 45 also includes a memory control unit 75 to control the storage of data in the memories 71 to 74B. In this embodiment, the DSP 63 and the memory control unit 75 together form a control unit that specifies the position of the defect using the defect data and selectively stores in the memories control data that relates to the peripheral area including the position of the defect.

The calculation units 81 to 84 performs a calculation according to the blanking data, shot data, main deflection data, auxiliary deflection data and the like, respectively, to generate calculation data to control the deflectors 31 to 34. The calculation data are output via I/O circuits 91 to 94 to the D/A converters 46 to 49, thereby providing the patterning operation as shown in FIG. 2.

The DSP 63 receives the main deflection data as input. The DSP 63 also receives the defect data as input from the defect inspector 700 via the host computer 600 and CPU 41. The DSP 63 also instructs the FIFO memories 61, 62, and 64 to transfer the blanking data, shot data, and auxiliary deflection data, respectively.

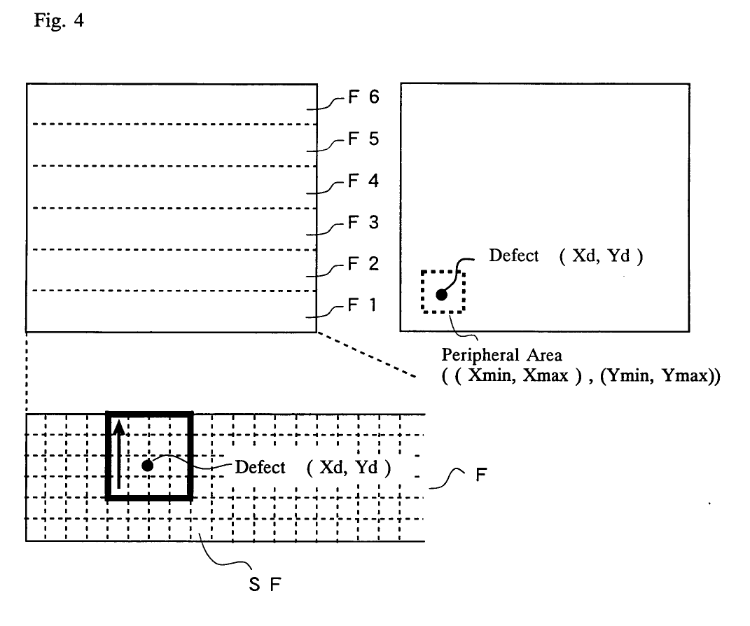

The electron beam lithography system 1 has a function of receiving the defect data from the defect inspector 700 and using the defect data to determine whether the defect is due to an error in the electron beam lithography system 1. When the operation of the error detection mode is specified to perform the above function, the DSP 63 specifies the position of the defect using the defect data, and determines an area (hereinafter referred to as a peripheral area) that includes the defect position. This function is described below with reference to FIG. 4.

As shown in the right hand side of FIG. 4, when the defect data shows the presence of a defect (closed circle), the defect position is defined by coordinates (Xd, Yd), and then the peripheral area CF including the defect coordinates (Xd, Yd) is determined. By way of example, the peripheral area CF may be defined by the coordinates (Xd, Yd) as the center and the coordinates (Xmin, Xmax) and (Ymin, Ymax) including m-row and n-column sub-field areas SF (m×n areas). The peripheral area may be set at any size or the like depending on the storage capacity of the memories such as 71 to 74B and other hardware specifications or the like.

The data processing circuit 45 includes the memory control unit 75 as described above. When the error detection mode is in operation, the memory control unit 75 selectively stores various control data related to the peripheral area CF determined by the DSP 63 in the memories 71 to 74B. Specifically, the various control data are the control data related to the m-row and n-column sub-field areas SF (m×n areas) included in the peripheral area CF.

When the operation of the error detection mode is specified, the patterning data is processed as follows, as in the normal patterning operation. The patterning data is divided into the frame areas F1 to F6 and stored in the pattern memory 42. The divided data is further divided into units of sub-field areas SF to generate the control data. The control data is then stored in the memories 71 to 74B.

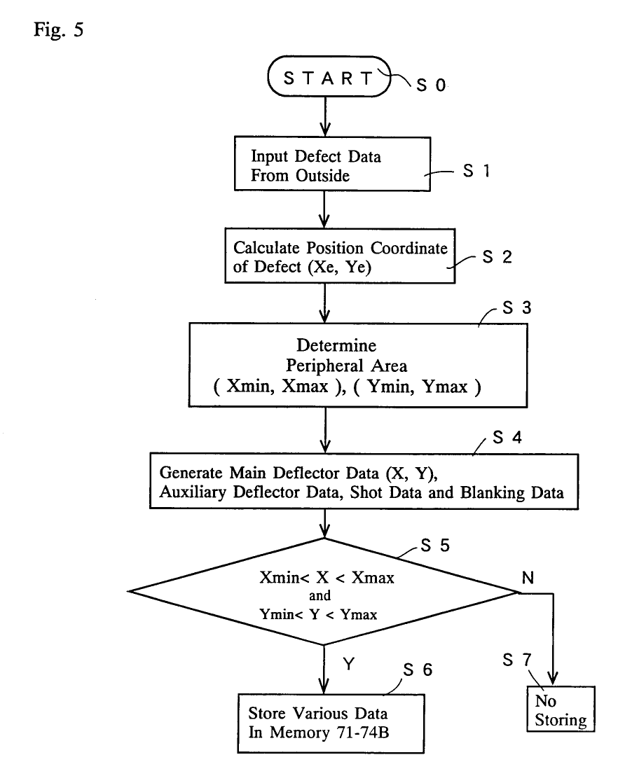

Note, however, that in the present embodiment, not all control data is stored in the memories 71 to 74B, and the memory control unit 75 selectively stores in the memories 71 to 74B the control data that is included in the peripheral area CF determined by the DSP 63 as described above. Specifically, the memories 71 to 74B only store the control data (shown as the heavy line square in FIG. 4) relating to the sub-field areas SF included in the peripheral area CF, among a large number of sub-field areas SF indicated by the main deflection data. Control data not corresponding to the peripheral area CF is prohibited from being stored in the memories 71 to 74B. This operation is specifically described with reference to FIG. 5.

The error detection mode is started (S0), and the defect data is inputted from outside via the host computer 600 and CPU 41 to the data processing circuit 45 (S1). The DSP 63 then computes from the defect data the defect coordinates (Xd, Yd)(S2). The DSP 63 also determines, using the coordinates as the center, the periphery area CF (Xmin, Xmax), (Ymin, Ymax) as the data collection range (S3).

The control data generation circuit 43 then generates, as in the normal patterning operation, the control data such as the main deflection data (X, Y), auxiliary deflection data, shot data, and blanking data (S4). The circuit 43 generates the control data according to the patterning data that is read from the hard disk drive 300 and stored in the pattern memory 42 for each frame area F.

The control data such as the main deflection data, auxiliary deflection data, shot data, and blanking data are inputted into the DSP 63, and the FIFO memories 64, 62, and 61 of the data processing circuit 45, respectively.

The DSP 63 receives the main deflection data (X, Y) as input. The DSP 63 then compares the coordinates (X, Y) of the main deflection data with the coordinates (Xmin, Xmax), (Ymin, Ymax) of the periphery area. If Xmin<X<Xmax and Ymin<Y<Ymax, in other words, the main deflection data is the control data related to the sub-field areas SF included in the periphery area CF (Y at S5), a positive flag is output to the memory control unit 75. In response, the memory control unit 75 stores the main deflection data and other control data associated with the main deflection data in the memories 71 to 74B (S6).

If, at S5, it is not true that Xmin<X<Xmax and Ymin<Y

<Ymax (N at S5), the DSP 63 outputs a negative flag to the memory control unit 75. In response, the memory control unit 75 does not store the associated control data into the memories 71 to 74B (S7). Specifically, the DSP 63 sends an instruction to prohibit such control data from being stored in the memories 71 to 74B.

Thus, the control data stored in the memories 71 to 74B are output to the CPU 41 and then to the host computer 600. The computer 600 then compares the control data with the original design pattern data to detect whether an error exists.

When the error detection mode is in operation, it is theoretically possible to store, as in the normal patterning operation, the control data in all sub-field areas SF in the memories 71 to 74B. The memory storage capacity may, however, be filled or overflows when the control data associated with the defect position is partially stored in the memory. It is then necessary to temporarily stop the storage of the data into the lithography system (not to overwrite the memories 71 to 74B), initialize the lithography system, and then resume to store the control data at a position slightly before the storage is stopped.

This operation is time consuming and is also an abnormal operation of the lithography system that provides lower reproducibility of the operation and inefficient error detection. When, therefore, an error is detected by stopping the lithography system each time an error is found, the actual patterning is not accurately reproduced, thereby providing lower reproducibility and lower efficiency.

In contrast, the present embodiment selectively stores only the control data around the defect position indicated by the defect data in the memories 71 to 74B. Even when, therefore, the memories 71 to 74B have limited storage capacity, an error in the lithography system that causes the defect may be detected accurately and efficiently without stopping or initializing the lithography system. The error detection without stopping the system may allow an error to be detected with the patterning operation being accurately reproduced.

Thus, although the invention has been described with respect to particular embodiments thereof, it is not limited to those embodiments. It will be understood that various modifications, substitutions, additions, deletions, and the like may be made without departing from the spirit of the present invention. Although, for example, FIG. 3 shows an example configuration of the data processing circuit 45, it is only an example where the data processing circuit 45 is implemented in hardware, and other hardware configuration may be used. The data processing circuit 45 may also be implemented in software.

Although, in the above embodiments, the peripheral area CF including the defect position is determined and the control data related to the sub-field areas SF included in the peripheral area CF are stored, alternatively, the sub-field areas included in the peripheral area CF may be specified using their sub-field numbers, and the control data related to the specified sub-field numbers may be selectively stored in the memory.

Although the above embodiments illustrate the electron beam lithography system using the variable shaped beam scheme and the continuous stage motion scheme, the present invention is applicable to electron beam lithography systems using other schemes. In addition to the electron beam lithography system, the present invention is also applicable to the lithography system using laser or the like.

What is claimed is:

1. A lithography system that deflects a beam to draw a desired pattern on a sample, the system comprising:
a beam optical system that includes a deflector to deflect the beam;
a driving unit that drives the deflector;
a data generation circuit that generates control data to control the driving unit according to patterning data representing the pattern to be drawn; and
a data processing circuit that processes the control data and outputs the processed data to the driving unit,
the data processing circuit comprising:
a memory that stores the inputted control data; and
a control unit that specifies a position where a defect of a pattern exists according to defect data as a result of inspection of a defect of a pattern actually drawn on the sample using a defect inspector and selectively stores in the memory the control data that relates to a peripheral area including the position of the defect.

2. The lithography system according to claim 1,
wherein the data generation circuit divides the patterning data into a plurality of sections, and generates at least main deflection data to deflect the beam to one of the sections, and
the control unit compares a position indicated by the main deflection data and the peripheral area, and stores in the memory the main deflection data that is included in the peripheral area and other control data associated with the main deflection data.

3. The lithography system according to claim 2,
wherein the control unit prohibits the main deflection data that is not included in the peripheral area and other control data associated with the main deflection data from being stored in the memory.

4. The lithography system according to claim 2,
wherein the data generation circuit further generates auxiliary deflection data for positioning in the section, and
the control unit stores the main deflection data that is included in the peripheral area and auxiliary deflection data associated with the main deflection data in the memory as the other control data.

5. The lithography system according to claim 1, further comprising a stage that holds the sample thereon, continuously moves in the first direction, and stepwise moves in the second direction perpendicular to the first direction,
wherein the deflector comprises:
a main deflector that follows the motion of the stage in the first direction and positions the beam to one of sections; and an auxiliary deflector that positions the beam in that section.

6. The lithography system according to claim 5,
wherein the data generation circuit generates main deflection data to control the main deflector and auxiliary deflection data to control the auxiliary deflector, and
the control unit compares a position indicated by the main deflection data and the peripheral area, and stores the main deflection data that is included in the peripheral area and auxiliary deflection data associated with the main deflection data in the memory as the other control data.

7. The lithography system according to claim 1, further comprising:
a first data storage unit that stores the patterning data; and
a second data storage unit that temporarily stores a portion of the patterning data read from the first data storage unit,
wherein the data generation circuit generates the control data according to the patterning data stored in the second data storage unit.

8. The lithography system according to claim 1, wherein the memory is a first in first out (FIFO) memory.

9. A method of detecting an error in a lithography system, the method comprising:
inputting defect data as a result of inspection by a defect inspector inspecting a defect of a sample patterned by the lithography system;
specifying a position of the defect from the defect data;
generating, in the lithography system, control data to control the lithography system according to patterning data used in patterning the sample; and
selectively storing in a memory the generated control data that relates to a peripheral area including the specified defect position.

10. The method of detecting an error in a lithography system according to claim 9,
wherein
the control data generated in the step of generating control data includes main deflection data to deflect a beam to one of a plurality of sections into which the patterning data is divided, and
the step of storing includes comparing a position indicated by the main deflection data and the peripheral area, and storing in the memory the main deflection data that is included in the peripheral area and other control data associated with the main deflection data.

11. The method of detecting an error in a lithography system according to claim 10,
the step of storing includes prohibiting the main deflection data that is not included in the peripheral area and other control data associated with the main deflection data from being stored in the memory.

12. The method of detecting an error in a lithography system according to claim 10,
wherein the control data generated in the step of generating control data includes auxiliary deflection data for positioning in the section, and
the step of storing includes storing the main deflection data that is included in the peripheral area and auxiliary deflection data associated with the main deflection data in the memory as the other control data.
